(19) United States
(12) Patent Application Publication
(10) Pub. No.: US 2010/0302224 A1
(43) Pub. Date: Dec. 2, 2010

(54) PLASMA DISPLAY DEVICE

(75) Inventors: Yoon Chang Choi, Kyungsangbuk-do (KR); Byung Goo Kong, Kyungsangbuk-do (KR); Dong Soo Lee, Kyungsangbuk-do (KR); Seong Ho Kang, Kyungsangbuk-do (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 12/377,405

(22) PCT Filed: Apr. 12, 2008
(86) PCT No.: PCT/KR08/02079

§ 371 Date: Aug. 12, 2010

(30) Foreign Application Priority Data
Oct. 5, 2007 (KR) 10-2007-0100336

(51) Int. Cl. G09G 5/00; G09G 3/28

(52) U.S. Cl. 345/211; 345/60

(57) ABSTRACT

A plasma display device is provided. In the plasma display device, a plurality of scan electrodes are divided into one or more scan electrode groups, and different driving signals are applied to the scan electrode groups. More specifically, a minimum voltage detected during a set-down period of a reset period is made to be discrepant from a scan voltage, thereby reducing the amount by which wall charge is erased and stabilizing an address discharge. In addition, different driving signals are applied to a plurality of scan electrodes, and thus, it is possible to stabilize an address discharge even in scan electrodes to which a scan signal is applied late.

### TECHNICAL FIELD

The present invention relates to a plasma display device, and more particularly, to a driving signal for driving a plasma display panel included in a plasma display device.

### BACKGROUND ART

In general, a plasma display panel (PDP) includes an upper substrate, a lower substrate, and a plurality of barrier ribs which are disposed between the upper substrate and the lower substrate and define a plurality of cells, and each of the cells is filled with a main discharge gas such as neon (Ne), helium (He) or a mixed gas (Ne+He) of neon and helium and an inert gas including a small amount of xenon. When a discharge occurs due to a high-frequency voltage, an inert gas generates vacuum ultraviolet (UV) rays, and the UV rays excite a phosphor layer between the barrier ribs, thereby realizing an image. PDPs are thin and light-weighted and have long been expected to became dominant next-generation display devices.

As the size and the resolution of PDPs increase, the length of an address period increases. Thus, it is necessary to facilitate an address discharge.

### DISCLOSURE OF INVENTION

### Technical Solution

The present invention provides a plasma display device which can realize a stable address discharge.

According to an aspect of the present invention, there is provided a plasma display device including a plasma display panel (PDP) which includes an upper substrate, a lower substrate, a plurality of scan electrodes and a plurality of sustain electrodes that are disposed on the upper substrate, and a plurality of address electrodes that are disposed on the lower substrate; and a driving unit which applies driving signals to the scan electrodes, the sustain electrodes and the address electrodes, wherein the scan electrodes are divided into a plurality of scan electrode groups including first and second scan electrode groups, a plurality of scan signals are applied to the scan electrodes in units of the scan electrode groups, at least one of a plurality of subfields of a frame includes a reset period, an address period and a sustain period, the address period includes a first sub-address period during which the scan signals are applied to the first scan electrode group and a second sub-address period during which the scan signals are applied to the first scan electrode group, a first scan bias voltage is applied to the second scan electrode group during the first sub-address period, a second scan bias voltage is applied to at least one of the scan electrode groups during the second sub-address period, the first and second scan bias voltages are different from each other, and a minimum voltage of a set-down signal which is applied to the second scan electrode group during the reset period and has a voltage that gradually decreases is higher than a scan voltage applied to the scan electrodes during the address period.

A reduced voltage difference between the minimum voltage of the set-down signal and the scan voltage may vary from one scan electrode group to another.

A minimum voltage of a set-down signal applied to whichever of the scan electrode groups causes an address discharge first may be substantially the sane as the scan voltage.

The reduced voltage difference may be 5-35 V.

A first reduced voltage difference detected from a first subfield may be different from a second reduced voltage difference detected from a second subfield.

The second subfield may follow the first subfield, and the first reduced voltage may be greater than the second reduced voltage.

The at least one subfield may also include a pre-reset period which is followed by the reset period and during which a ramp-down signal having a voltage that gradually decreases is applied to the scan electrodes and a sustain bias signal having an opposite polarity to that of the ramp-down signal is applied to the sustain electrodes.

The scan signals may include a first scan signal and a second scan signal that have different widths.

A first width of a scan signal applied during the first sub-address period may be less than a second width of a scan signal applied during the second sub-address period.

The second width may be 1.2-1.6 times greater than the first width.

The first scan bias voltage may be higher than the second scan bias voltage and lower than a sustain voltage applied to the scan electrodes during the sustain period.

The first scan bias voltage is higher than the result of multiplying a maximum voltage of an address signal applied to the address electrodes and the second scan bias voltage by −1 and lower than a difference between a maximum voltage of a sustain signal and the maximum voltage of the address signal.

The first scan bias voltage may be a ground voltage.

The second scan bias voltage may be a negative voltage.

A scan bias voltage applied to the first scan electrode group during the first sub-address period may be substantially the same as the first scan bias voltage.

The reset period may include a set-up period during which a ramp-up signal having a voltage that gradually increases is applied to at least one of the scan electrode groups; and a set-down period during which a ramp-down signal having a voltage that decreases gradually, but not continually, is applied.

The scan electrodes nay be divided into a first scan electrode group including upper scan electrodes and a second scan electrode group including lower scan electrodes.

The scan electrodes may be divided into a first scan electrode group including odd-numbered scan electrodes and a second scan electrode group including even-numbered scan electrodes.

According to another aspect of the present invention, there is provided a method of driving a PDP which includes an upper substrate, a lower substrate, a plurality of scan electrodes and a plurality of sustain electrodes that are disposed on the upper substrate, and a plurality of address electrodes that are disposed on the lower substrate, wherein the scan electrodes are divided into a plurality of scan electrode groups including first and second scan electrode groups, a plurality of scan signals are applied to the scan electrodes in units of the scan electrode groups, at least one of a plurality of subfields of a frame includes a reset period, an address period and a sustain period, the address period includes a first sub-address period during which the scan signals are applied to the first scan electrode group and a second sub-address period during which the scan signals are applied to the first scan electrode group, a first scan bias voltage is applied to the second scan electrode group during the first sub-address period, a second scan bias voltage is applied to at least one of the scan electrode groups during the second sub-address period, the first and second scan bias voltages are different from each other, and a minimum voltage of a set-down signal which is applied to the second scan electrode group during the reset period and has a voltage that gradually decreases is higher than a scan voltage applied to the scan electrodes during the address period.

A reduced voltage difference between the minimum voltage of the set-down signal and the scan voltage may vary from one scan electrode group to another.

### BRIEF DESCRIPTION OF THE DRAWINGS

FIG. 1 illustrates a perspective view of a plasma display panel (PDP) according to an embodiment of the present invention;

FIG. 2 illustrates a cross-sectional view of an arrangement of electrodes in a PDP;

FIG. 3 illustrates a timing diagram for explaining a time-division method of driving a PDP in which a frame is divided into a plurality of subfields;

FIG. 4 illustrates a timing diagram of the waveforms of driving signals for driving a PDP, according to an embodiment of the present invention;

FIG. 5 illustrates a diagram of an apparatus for driving a PDP according to an embodiment of the present invention;

FIG. 6 illustrates a timing diagram of the waveforms of driving signals for driving a PDP during one subfield, according to an embodiment of the present invention;

FIGS. 7 through 10 illustrate timing diagram of the waveforms of driving signals applied to scan electrodes, according to embodiments of the present invention;

FIGS. 11 through 13 illustrate timing diagrams of scan signals according to embodiments of the present invention;

FIG. 14 graphs of the relationship between luminance and the ratio of the width of a scan signal applied to a first scan electrode group and the width of a scan signal applied to a second scan electrode group and the relationship between the duration of a scan period and the ratio of the width of a scan signal applied to the first scan electrode group and the width of a scan signal applied to the second scan electrode group; and

FIG. 15 illustrates a timing diagram of the waveforms of driving signals according to another embodiment of the present invention.

### MODE FOR THE INVENTION

The present invention will now be described more fully with reference to the accompanying drawings, in which exemplary embodiments of the invention are shown.

The present invention will hereinafter be described in detail with reference to the accompanying drawings in which exemplary embodiments of the invention are shown.

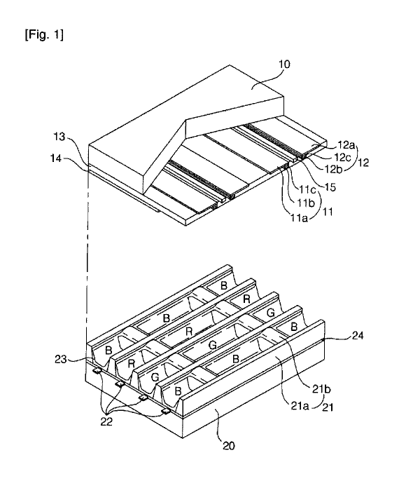

FIG. 1 illustrates a perspective view of a display device according to an embodiment of the present invention. Referring to FIG. 1, a plasma display panel (PDP) includes an upper substrate 10, a plurality of electrode pairs which are formed on the upper substrate 10 and consist of a scan electrode 11 and a sustain electrode 12 each; a lower substrate 20; and a plurality of address electrodes 22 which are formed on the lower substrate 20.

Each of the electrode pairs includes transparent electrodes 11a and 12a and bus electrodes 11b and 12b. The transparent electrodes 11a and 12a may be formed of indium-tin-oxide (ITO). The bus electrodes 11b and 12b may be formed of a metal such as silver (Ag) or chromium (Cr) or may comprise a stack of chromium/copper/chromium (Cr/Cu/Cr) or a stack of chromium/aluminium/chromium (Cr/Al/Cr). The bus electrodes 11b and 12b are respectively formed on the transparent electrodes 11a and 12a and reduce a voltage drop caused by the transparent electrodes 11a and 12a which have a high resistance.

Alternatively, each of the electrode pairs may include the bus electrodes 11b and 12b only. In this case, the manufacturing cost of the PDP can be reduced by not using the transparent electrodes 11a and 12a. The bus electrodes 11b and 12b may be formed of various materials other than those set forth herein, e.g., a photosensitive material.

Black matrices are formed on the upper substrate 10. The black matrices perform a light shied function by absorbing external light incident upon the upper substrate 10 so that light reflection can be reduced. In addition, the black matrices enhance the purity and contrast of the upper substrate 10.

In detail, the black matrices include a first black matrix 15 which overlaps a plurality of barrier ribs 21, a second black matrix 11 c which is formed between the transparent electrode 11a and the bus electrode 11b of each of the scan electrodes 11, and a second black matrix 12c which is formed between the transparent electrode 12a and the bus electrode 12b. The first black matrix 15 and the second black matrices 11c and 12c, which can also be referred to as black layers or black electrode layers, may be formed at the same time and may be physically connected. Alternatively, the first black matrix 15 and the second black matrices 11c and 12c may not be formed at the same time, and may not be physically connected.

If the first black matrix 15 and the second black matrices 11c and 12c are physically connected, the first black matrix 15 and the second black matrices 11c and 12c may be formed of the same material. On the other hand, if the first black matrix 15 and the second black matrices 11c and 12c are physically separated, the first black matrix 15 and the second black matrices 11c and 12c may be formed of different materials.

An upper dielectric layer 13 and a passivation layer 14 are deposited on the upper substrate 10 on which the scan electrodes 11 and the sustain electrodes 12 are formed in parallel with one other. Charged particles generated as a result of a discharge accumulate in the upper dielectric layer 13. The upper dielectric layer 13 may protect the electrode pairs. The passivation layer 14 protects the upper dielectric layer 13 from sputtering of the charged particles and enhances the discharge of secondary electrons.

The address electrodes 22 are formed and intersect the scan electrodes 11 and the sustain electrodes 12. A lower dielectric layer 23 and the barrier ribs 21 are formed on the lower substrate 20 on which the address electrodes 22 are formed. A phosphor layer 23 is formed on the lower dielectric layer 23 and the barrier ribs 21.

The phosphor layer 23 is excited by UV rays that are generated upon a gas discharge.

As a result, the phosphor layer 23 generates one of R, G, and B rays. A discharge space is provided between the upper and lower substrates 10 and 20 and the barrier ribs 21. A mixture of inert gases, e.g., a mixture of helium (He) and xenon (Xe), a mixture of neon (Ne) and Xe, or a mixture of He, Ne, and Xe is injected into the discharge space.

Red (R), green (G), and blue (B) discharge cells may be formed as stripes. However, the present invention is not restricted to this. For example, R, G, and B discharge cells may be formed as triangles or deltas. Alternatively, R, G, and B discharge cells may be formed as polygons such as rectangles, pentagons, or hexagons.

The R, G and B discharge cells may have the same width. Alternatively, at least one of the R, G and B discharge cells may have a different width from that of the other discharge cells.

The barrier ribs 21 define a plurality of discharge cells and prevent ultraviolet (UV) rays and visible rays generated in one discharge cell due to a gas discharge from leaking into other discharge cells. The barrier ribs 21 may define the discharge cells as stripes, wells, deltas, or honeycombs. The barrier ribs 21 may include vertical barrier ribs 21a and horizontal barrier ribs 21b and define the discharge cells in a closed-type manner

The present invention can be applied not only to a barrier rib structure illustrated in FIG. 1 but also to other various barrier rib structures. For example, the present invention can be applied to a differential barrier rib structure in which the height of vertical barrier ribs 21a is different from the height of horizontal barrier ribs 21b, a channel-type barrier rib structure in which a channel that can be used as an exhaust passage is formed in at least one vertical or horizontal barrier rib 21a or 21b, and a hollow-type bather rib structure in which a hollow is formed in at least one vertical or horizontal barrier rib 21a or 21b.

In the differential barrier rib structure, the height of horizontal barrier ribs 21b may be greater than the height of vertical barrier ribs 21a. In the channel-type barrier rib structure or the hollow-type barrier rib structure, a channel or a hollow may be formed in at least one horizontal barrier rib 21b.

In the embodiment of FIG. 1, the barrier ribs 21 are formed only on the lower substrate 20. However, the barrier ribs 21 may also be arranged on the upper substrate 10.

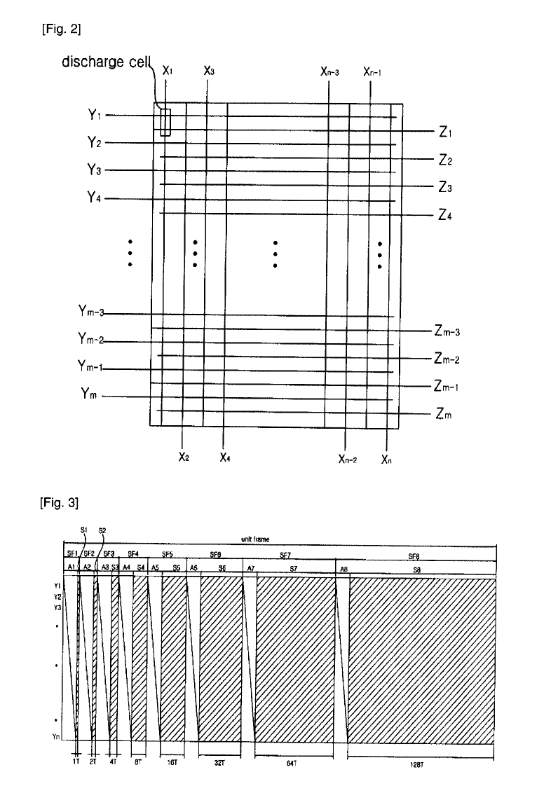

FIG. 2 illustrates a cross-sectional view of an arrangement of electrodes in a PDP. Referring to FIG. 2, a plurality of discharge cells that constitute a PDP may be arranged in a matrix. The discharge cells are respectively disposed at the intersections between a plurality of scan electrode lines Y₁ through Yₘ and a plurality of address electrode lines X₁ through Xₙ or the intersections between a plurality of sustain electrode lines Z₁ through Zₘ and the address electrode lines X₁ through Xₙ. The scan electrode lines Y₁ through Yₘ may be sequentially or simultaneously driven. The sustain electrode lines Z₁ through Zₘ may be simultaneously driven. The address electrode lines X₁ through Xₙ may be divided into two groups: a group including odd-numbered address electrode lines and a group including even-numbered address electrode lines. The address electrode lines X₁ through Xₙ may be driven in units of the groups or may be sequentially driven.

The electrode arrangement illustrated in FIG. 2, however, is exemplary, and thus, the present invention is not restricted to this. For example, the scan electrode lines Y₁ through Yₘ may be driven using a dual scan method in which two of a plurality of scan lines are driven at the same time. The address electrode lines X₁ through Xₙ may be divided into two groups: a group including upper address electrode lines that are disposed in the upper half of a PDP and a group including lower address electrode lines that are disposed in the lower half of the PDP. Then, the address electrode lines X₁ through Xₙ may be driven in units of the two groups.

FIG. 3 illustrates a timing diagram for explaining a time-division method of driving a PDP in which a frame is divided into a plurality of subfields. Referring to FIG. 3, a unit frame is divided into a predefined number of subfields, for example, eight subfields SF1 through SF8, in order to realize a time-division grayscale display. Each of the subfields SF1 through SF8 is divided into a reset period (not shown), an address period (A1, . . . , A8), and a sustain period (S1, . . . , S8).

Not all the subfields SF1 through SF8 may have a reset period. For example, only the first subfield SF1 may have a reset period, or only the first subfield and a middle subfield may have a reset period.

During each of the address periods Al through A8, a display data signal is applied to an address electrode X, and a scan pulse is applied to a scan electrode Y so that wall charges can be generated in a discharge cell.

During each of the sustain periods S1 through S8, a sustain pulse is alternately applied to the scan electrode Y and a sustain electrode Z so that a discharge cell can cause a number of sustain discharges.

The luminance of a PDP is proportional to the total number of sustain discharge pulses allocated during the sustain discharge periods S1 through S8. Assuming that a frame for one image includes eight subfields and is represented with 256 grayscale levels, 1, 2, 4, 8, 16, 32, 64, and 128 sustain pulses may be respectively allocated to the sustain periods S1, S2, S3, S4, S5, S6, S7, and S8. In order to obtain luminance corresponding to a grayscale level of 133, a plurality of discharge cells may be addressed during the first, third, and eighth subfields SF1, SF3, and SF8 so that they can cause a total of 133 sustain discharges.

The number of sustain discharges allocated to each of the subfields SF1 through SF8 may be determined according to a weight allocated to a corresponding subfield through automatic power control (APC). Referring to FIG. 3, a frame is divided into eight subfields, but the present invention is not restricted to this. In other words, the number of subfields in a frame may be varied. For example, a PDP may be driven by dividing each frame into more than eight subfields (e.g., twelve or sixteen subfields).

The number of sustain discharges allocated to each of the subfields SF1 through SF8 may be varied according to gamma and other characteristics of a PDP. For example, a grayscale level of 6, instead of a grayscale level of 8, may be allocated to the subfield SF4, and a grayscale level of 34, instead of a grayscale level of 32, may be allocated to the subfield SF6.

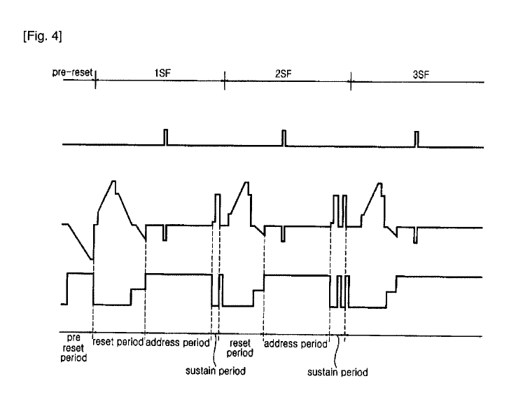

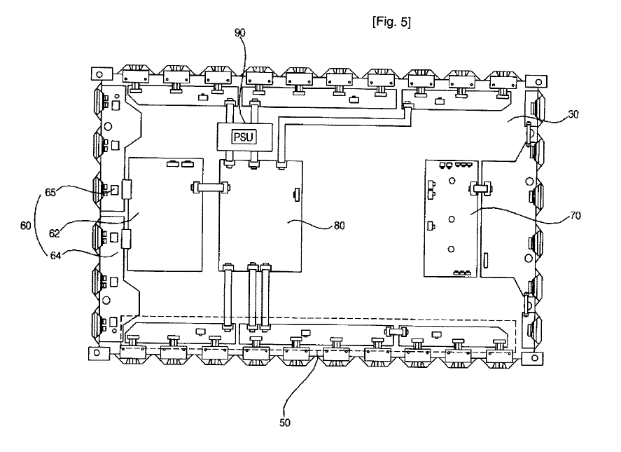

FIG. 4 illustrates a timing diagram of the waveforms of driving signals for driving a PDP, according to an embodiment of the present invention. Referring to FIG. 4, a subfield may include a pre-reset period for generating positive wall charges in scan electrodes Y and generating negative wall charges in sustain electrodes Z; a reset period for initializing discharge cells of a previous frame using the distribution of the wall discharges generated during the pre-reset period; an address period for selecting discharge cells; and a sustain period for sustaining gas discharges in the selected discharge cells.

A reset period includes a set-up period and a set-down period. During a set-up period, a ramp-up waveform is applied to all the scan electrodes Y at the same time so that each of the discharge cells can cause a weak discharge, and that wall charges can be generated in each of the discharge cells. During a set-down period, a ramp-down signal having a voltage that decreases gradually, but not continually, from a peak voltage of the ramp-up waveform is applied to all the scan electrodes Y so that each of the discharge cells can cause an erase discharge, and that whichever of space charges and the wall charges generated during the set-up period are unnecessary can be erased.

During an address period, a negative scan signal Vsc is sequentially applied to the scan electrodes Y, and at the same time, a positive data signal is applied to the address electrodes X. Due to the difference between the negative scan signal Vsc and the positive data signal and wall charges generated during a reset period, an address discharge occurs, and thus, discharge cells are selected. During an address period, a sustain bias voltage Vzb is applied to the sustain electrodes Z in order to increase the efficiency of an address discharge.

The scan electrodes Y may be divided into two or more groups. Then, a scan signal may be sequentially applied to each of the groups during an address period. For example, the scan electrodes Y may be divided into first and second groups. Then, a scan signal is sequentially applied to scan electrodes Y belonging to the first group and then to scan electrodes Y belonging to the second group.

The scan electrodes Y may be divided into a first group including even-numbered scan electrodes Y and a second group including odd-numbered scan electrodes Y. Alternatively, the scan electrodes Y may be divided into a first group including upper scan electrodes Y and a second group including lower scan electrodes Y.

A group of scan electrodes Y may be further divided into one or more sub-groups, for example, a first sub-group including even-numbered scan electrodes Y and a second sub-group including odd-numbered scan electrodes Y or a first sub-group including upper scan electrodes Y and a second sub-group including lower scan electrodes Y.

During a sustain period, a sustain pulse having a sustain voltage Vs is alternately applied to the scan electrodes Y and the sustain electrodes Z so that surface discharges can occur between the scan electrodes Y and the respective sustain electrodes Z as sustain discharges.

The width of a first sustain signal and a last sustain signal of a plurality of sustain signals that are alternately applied to the scan electrodes Y and the sustain electrodes Z may be greater than the width of the other sustain signals.

An erase period may be provided after a sustain period in order to cause a weak discharge and thus to erase wall charges remaining, even after a sustain discharge, in the scan electrode Y or the sustain electrode Z of a discharge cell (i.e., an on cell) selected during an address period.

An erase period may be included in all subfields of a frame or only in some subfields of a frame. During an erase period, an erase signal for causing a weak discharge may be applied to electrodes to which a last sustain pulse has not been applied during a sustain period.

A ramp signal, a low-voltage wide pulse, a high-voltage narrow pulse, an exponential signal or a half-sinusoidal pulse may be used as the erase signal.

Also, in order to cause a weak discharge during an erase period, a plurality of pulses may be sequentially applied to a scan electrode or a sustain electrode.

The waveforms illustrated in FIG. 4 are exemplary, and thus, the present invention is not restricted thereto. For example, a pre-reset period may be optional. In addition, the polarities and voltages of driving signals used to drive a PDP are not restricted to those illustrated in FIG. 4, and may be altered in various manners An erase signal for erasing wall charges may be applied to a sustain electrode after a sustain discharge. A sustain signal may be applied to either a scan electrode or a sustain electrode, thereby realizing a single-sustain driving method.

FIG. 5 illustrates a diagram of an apparatus for driving a PDP according to an embodiment of the present invention. Referring to FIG. 5, a heat dissipation frame 30 is disposed on a bottom surface of a PDP. The heat dissipation frame 30 supports the PDP, and absorbs heat generated by the PDP and discharges the heat. A printed circuit board (PCB) 40 is installed on a rear surface of the heat dissipation frame 30. The PCP 40 applies a number of driving signals to the PDP.

The PCB 40 may include an address driving unit 50 which applies a driving signal to address electrodes; a scan driving unit 60 which applies a driving signal to scan electrodes; a sustain driving unit 70 which applies a driving signal to sustain electrodes; a driving control unit which controls the address driving unit 50, the scan driving unit 60 and the sustain driving unit 70; and a power supply unit (PSU) 90 which supplies power to the address driving unit 50, the scan driving unit 60 and the sustain driving unit 70.

The address driving unit 50 applies a driving signal to address electrodes so that only discharge cells that are discharged can be selected.

Only one address driving unit 50 or two address driving units 50 may be provided according to whether the PDP adopts a single scan method or a dual scan method. If only one address driving unit 50 is provided, it may be disposed either above or below the PDP. On the other hand, if two address driving units 50 are provided, they may be respectively disposed above and below the PDP.

The address driving unit 50 may include a data integrated circuit (IC) (not shown) for controlling a current applied to address electrodes. Switching may occur in the data IC during the control of a current applied to address electrodes, and thus, a considerable amount of heat may be generated. In order to address this, a heat sink (not shown) may be installed in the address driving unit 50.

Referring to FIG. 5, the scan driving unit 60 may include a scan sustain board 62 which is connected to the driving control unit 80 and a scan driver board 64 which connects the scan sustain board 62 and the PDP.

The scan driver board 64 may be divided into two portions: upper and lower portions. Alternatively, the scan driver board 64 may be formed as one body or may be divided into more than two portions.

A scan IC 65 is installed on the scan driver board 64. The scan IC 65 applies driving signals to scan electrodes. More specifically, the scan IC 65 may sequentially apply a reset signal, a scan signal and a sustain signal to scan electrodes.

The sustain driving unit 70 applies a driving signal to sustain electrodes.

The driving control unit 80 converts an input image signal into data by performing signal processing on the input image signal using signal processing information present in a memory (not shown). Then, the driving control unit 80 aligns the data according to a predefined scan order. The driving control unit 80 may apply a timing control signal to the address driving unit 50, the scan driving unit 60 and the sustain driving unit 70 and thus control the tiring of the application of driving signals.

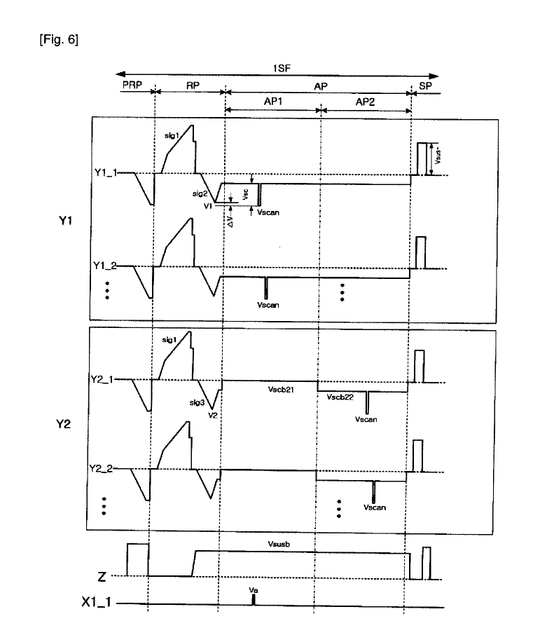

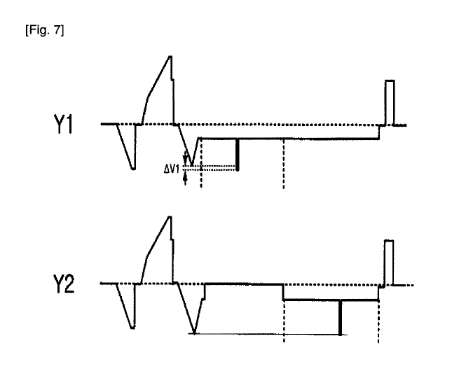

FIG. 6 illustrates a timing diagram of the waveforms of driving signals for driving a PDP during a subfield, according to an embodiment of the present invention, and FIGS. 7 through 10 illustrate timing diagram of the waveforms of driving signals applied to scan electrodes, according to embodiments of the present invention. Referring to FIG. 6, a subfield includes a pre-reset period PRP for forming positive charges in a plurality of scan electrodes Z and forming negative wall charges in a plurality of sustain electrodes Z, a reset period RP for initializing discharge cells of a previous frame using the distribution of wall charges formed during the pre-reset period, an address period AP for selecting discharge cells, and a sustain period SP for maintaining the selected discharge cells to cause a discharge.

Referring to FIG. 6, the scan electrodes Y may be divided into two groups: a first scan electrode groups Y1 to which a scan signal is applied first and a second scan electrode groups Y2. The address period AP may be divided into a first sub-address period AP1 for applying a scan signal to the first scan electrode group Y1 and a second sub-address period AP2 for applying a scan signal to the second scan electrode group Y2. During the first sub-address period AP1, a scan signal may be sequentially applied to scan electrodes Y belonging to the first scan electrode group Y1. During the second sub-address period AP2, a scan signal may be sequentially applied to scan electrodes Y belonging to the second scan electrode group Y2.

For example, the first scan electrode group Y1 may include even-numbered scan electrodes Y, and the second scan electrode group Y2 may include odd-numbered scan electrodes Y. Alternatively, the first scan electrode group Y1 may include upper scan electrodes Y, and the second scan electrode group Y2 may include lower scan electrodes Y. The scan electrodes Y may be divided into one or more groups according to a different rule from those set forth herein. The number of scan electrodes Y belonging to the first scan electrode group Y1 may be different from the timber of scan electrodes Y belonging to the second scan electrode group Y2.

During the reset period RP, negative charges are generated in the scan electrodes Y for causing an address discharge. During the address period AP, a driving signal having a scan bias voltage is applied to the scan electrodes Y and then a negative scan signal may be sequentially applied to the scan electrodes Y. As a result, an address discharge occurs.

During the address period AP, a negative scan bias voltage may be applied to the scan electrodes Y so that the difference between the electric potential of a data signal applied to address electrodes X and the electric potential of a scan voltage can increase, and that an address discharge can be facilitated.

In the case of applying a scan signal to the first scan electrode group Y1 and then to the second scan electrode group Y2, a scan signal is applied to the first scan electrode group Y1 during the first sub-address period AP1. However, during the first sub-address period API, negative wall charges may be erased from the second scan electrode group Y2. Then, no address discharge may occur regardless of the application of a scan signal to the second scan electrode group Y2, i.e., an address misdischarge may occur.

Therefore, referring to FIG. 6, a scan bias voltage Vscb21, which is applied to the second scan electrode group Y2 during the first sub-address period AP1, may be increased, thereby reducing the loss of negative wall charges in the second scan electrode group Y2.

In the embodiment of FIG. 6, during the first sub-address period AP1, the scan bias voltage Vscb21 is applied to the second scan electrode group Y2. During the second sub-address period AP2, a scan bias voltage Vscb22 is applied to the second scan electrode group Y2. The scan bias voltage Vscb21 and the scan bias voltage Vscb22 are different from each other.

The scan bias voltage Vscb22 may be provided for increasing an electric potential difference with a data signal, and the scan bias voltage Vscb21 may be provided for holding wall charges in the scan electrodes Y. Therefore, the scan bias voltage Vscb21 may be higher than the scan bias voltage Vscb22.

Referring to FIG. 6, during the address period AP, a scan bias voltage applied to the second scan electrode group Y2 may vary. More specifically, the scan bias voltage Vscb21, which is applied to the second scan electrode group Y2 during the first sub-address period AP1, may be higher than the scan bias voltage Vscb22, which is applied to the second scan electrode group Y2 during the second sub-address period AP2.

If the first scan electrode group Y1 includes even-numbered scan electrodes and the second scan electrode group Y2 includes odd-numbered scan electrodes, different scan bias voltages (i.e., a scan bias voltage Vscb1 and the scan bias voltage Vscb21) may be applied to the first and second scan electrode groups Y1 and Y2, thereby reducing the influence of interference between adjacent discharge cells.

The scan bias voltage Vscb21 may be lower than a sustain voltage Vsus1. In this case, it is possible to prevent an increase in the power consumption of a plasma display device and to reduce the probability of the occurrence of a spot misdischarge due to an increase in the amount of wall discharge in the scan electrodes Y.

As described above, the scan bias voltage Vscb21 may be higher than the scan bias voltage Vscb22. However, if the scan bias voltage Vscb21 is only slightly higher than the scan bias voltage Vscb22, it may be difficult to effectively prevent the loss of wall charges. Therefore, the scan bias voltage Vscb21 may be higher than the result of multiplying the sun of a maximum voltage Va (not shown) of an address signal applied to the address electrodes X and the scan bias voltage Vscb22 by −1. Then, it is possible to effectively prevent the loss of wall charges. In addition, it is possible to prevent the occurrence of crosstalk regardless of the occurrence of an address discharge in the first scan electrode group Y1 during the first sub-address period API.

Due to the address voltage Va, which is applied to the address electrodes X during the first sub-address period AP1, a misdischarge may occur. If a positive voltage applied to the scan electrodes is too mach discrepant from the voltage of negative wall charges, negative wall charges may be transferred to the scan electrodes Y. Therefore, the scan bias voltage Vscb21 may be lower than the result of subtracting the address voltage Va from the sustain voltage Vsus1.

In order to facilitate an address discharge during the address period AP, the first scan bias voltage Vscb1 and the scan bias voltage Vscb22 may both be set to negative values. In order to facilitate the configuration of a driving circuit, the scan bias voltage Vscb21 may be a ground voltage GND, and the scan bias voltage Vscb1, which is applied to the first scan electrode group Y1 during the address period AP, may be uniformly maintained. In addition, the scan bias voltage Vscb22 may be substantially the same as the scan bias voltage Vscb1.

In the embodiment of FIG. 6, the sum of the scan bias voltage Vscb1 and the voltage of the negative scan signal Vsc may be the same as the sun of the scan bias voltage Vscb22 and the voltage of the negative scan signal Vsc. Thus, there is no need to provide any additional driving circuit.

The embodiment of FIG. 6 may be applied to at least some of a plurality of subfields of a frame. For example, the embodiment of FIG. 6 may be applied to at least one of the subfields subsequent to the first subfield.

A pulse-type rectangular wave is applied to the scan electrodes Y as a scan signal in synchronization with a scan time. If the scan bias voltage Vscb1 is 0 V, a scan voltage Vscan may be the same as an amplitude Vsc of the rectangular wave. On the other hand, if the scan bias voltage Vscb1 is not 0 V, the scan voltage Vscan may be the same as the sum of the amplitude Vsc of the rectangular wave and the scan bias voltage Vscb1. In short, the scan voltage Vscan, which is applied to the first scan electrode group Y1, may be the same as the sum of the amplitude Vsc of a scan pulse and the scan bias voltage Vscb1.

The difference between the scan voltage Vscan and a minimum voltage detected during the set-down period of the reset period RP will hereinafter be referred to as a reduced voltage difference ΔV.

Referring to FIG. 7, a reduced voltage difference ΔV of the first scan electrode group Y1 is greater than 0. That is, a minimum voltage V1 detected from the first scan electrode group Y1 during the set-down period of the reset period RP is higher than the scan voltage Vscan. Therefore, an erase discharge may occur less severely during the set-down period of the reset period RP, and thus, an address discharge or sustain discharge may be stably performed. In particular, if the first scan electrode group Y1 is scanned first, a sustain discharge, rather than an address discharge, may be stabilized during the sustain period SP. Since it takes a considerable amount of time to scan another scan group after the scan of the first scan electrode group Y1, a less amount of wall charge is erased in consideration of the amount by which wall charge is reduced, thereby facilitating a sustain discharge.

Not only the first scan electrode group Y1 but also the second scan electrode group Y2 may have. More specifically, a reduced voltage difference ΔV may be generated in at least one of the first scan electrode group Y1 and the second scan electrode group Y2.

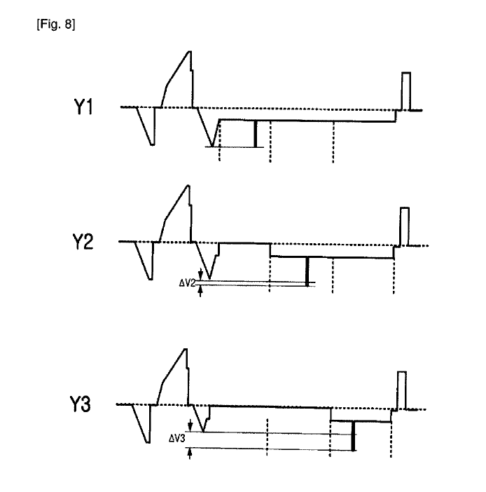

Referring to FIG. 8, a plurality of scan electrodes Y are divided into three scan electrode groups: first, second and third scan electrode groups Y1, Y2 and Y3. A scan signal is sequentially applied to the first, second and third scan electrodes Y1, Y2 and Y3. A reduced voltage difference ΔV of 0 is generated in the first scan electrode group Y1, which is scanned first. Since the first scan electrode group Y1 is scanned first and thus it takes a short time to scan the first scan electrode group Y1 after a reset period RP, an address discharge is stabilized even if a sufficient amount of wall charge is erased.

A second reduced voltage difference ΔV2 is generated in the second scan electrode group Y2, which is scanned after the scan of the first scan electrode group Y1. Since it takes time to scan the second scan electrode group Y2 after the scan of the first scan electrode group Y1, it is necessary to control a less amount of wall charge to be erased.

A third reduced voltage difference V3 is generated in the third scan electrode group Y3, which is scanned after the scan of the second scan electrode group Y2. The third reduced voltage difference ΔV is less than the second reduced voltage difference ΔV2. Since the third scan electrode group Y3 is scanned last and thus it takes a considerable amount of time to scan the third scan electrode group Y3 after the scan of the second scan electrode group Y2, it is necessary to control a much less amount of wall charge to be erased.

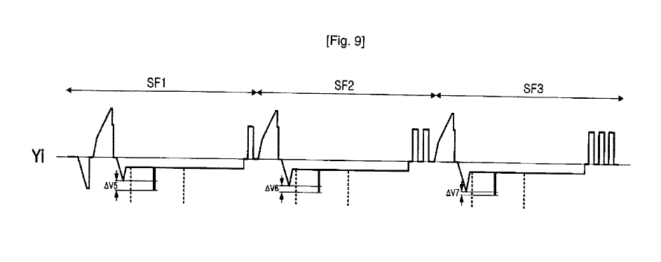

FIG. 9 illustrates the application of a driving signal to an arbitrary scan electrode Yi during first through third subfields SF1 through SF3 of a frame, according to an embodiment of the present invention.

In the embodiment of FIG. 6, a first subfield of a frame includes a pre-reset period. During the pre-reset period, a ramp-down signal having a voltage that decreases gradually, but not continually, is applied to scan electrodes, and a sustain bias signal having the opposite polarity to that of the ramp-down signal is applied to sustain electrodes Z.

During the pre-reset period, positive wall charges are formed in the scan electrodes, and negative wall charges are formed in the sustain electrodes Z. During the pre-reset period, wall charges are sufficiently accumulated in discharge cells. Thus, it is possible to facilitate a reset discharge during a reset period.

A reduced voltage difference ΔV may vary from one subfield to another of a frame. The reduced voltage difference ΔV may gradually decrease from the beginning of a frame to the end of the frame. Referring to FIG. 9, a fifth reduced voltage difference ΔV5 of the first subfield SF1 is greater than a sixth reduced voltage difference ΔV6 of the second subfield SF2, and the sixth reduced voltage difference ΔV6 is greater than a seventh reduced voltage difference ΔV7 of the third subfield SF3. In the case of late subfields of a frame, a large number of sustain discharges occurs, and thus, the amount of wall charge or spatial charge is sufficient not to cut short an erase discharge.

FIG. 10 illustrates graphs of the relationships between address discharge rate and a reduced voltage difference ΔV and between the frequency of occurrence of a misdischarge and the reduced voltage difference ΔV. Referring to FIG. 10, a horizontal axis represents the reduced voltage difference ΔV, a left vertical axis represents address discharge rate, i.e., on cell rate, and a right vertical axis represents the frequency of occurrence of a misdischarge.

Referring to FIG. 10, as the reduced voltage difference ΔV exceeds 5 V, the on cell rate considerably increases because there is a sufficient amount of wall charge to smoothly perform an address discharge. However, if an excessive amount of wall charge is provided, crosstalk is highly likely to occur, and thus, the frequency of occurrence of a misdischarge increases. A rapid increase in the frequency of occurrence of a misdischarge can be prevented as long as the reduced voltage difference ΔV is less than 30 V. Therefore, the reduced voltage difference ΔV may be within the range of 5 V to 30 V. In this case, it is possible to provide high address discharge rate while keeping the frequency of occurrence of a misdischarge low.

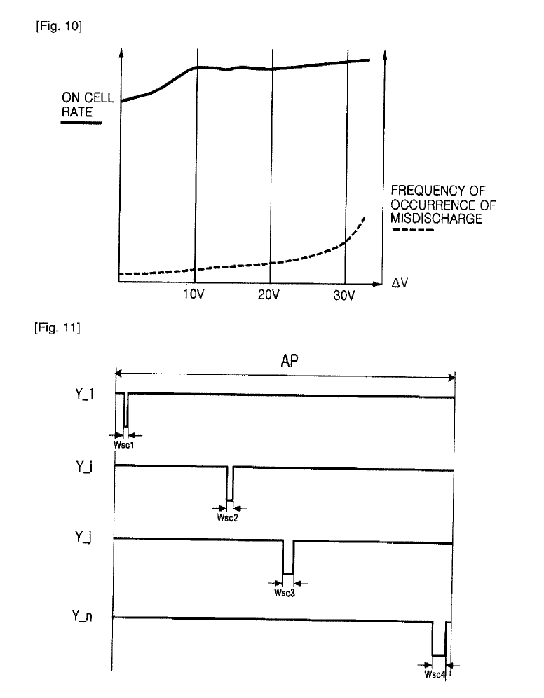

FIGS. 11 through 13 illustrate timing diagrams of scan signals according to embodiments of the present invention.

Different scan signals may be applied to different scan electrodes. More specifically, referring to FIG. 11, n scan signals may be sequentially applied to first through n-th scan electrodes Y_1 through Y_n, respectively. Widths Wsc1, Wsc2, Wsc3 and Wsc4 of scan signals respectively applied to the first, i-th, j-th and n-th scan electrodes may be set to satisfy Equation (1):

Wsc1<Wsc2<Wsc3<Wsc4.

That is, in the embodiment of FIG. 11, the width of a scan signal applied at a later stage of an address period AP may be set to be greater than the width of a scan signal applied at an early stage of an address period AP, thereby enabling an address discharge to be stably performed.

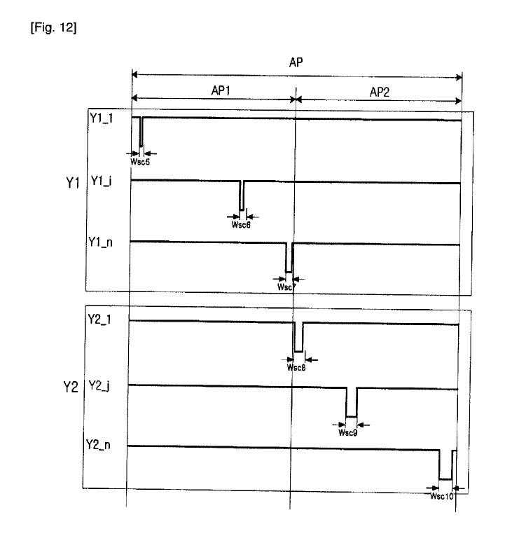

Referring to FIG. 12, a plurality of scan electrodes are divided into one or more scan electrode groups. Then, the width of a scan signal applied to a scan electrode belonging to the first scan electrode group Y1 may be set to be greater than the width of a scan signal applied to a scan electrode belonging to the second scan electrode group Y2, and the width of a scan signal applied at a later stage of an address period may be set to be greater than the width of a scan signal applied at an early stage of the address period. Referring to FIG. 12, widths Wsc5, Wsc6, and Wsc7 of scan signals respectively applied to first, i-th and n-th scan electrodes Y1_1, Y1_{—}i, and Y1_{—}n belonging to the first scan electrode group Y1 and widths Wsc8, Wsc9, and Wsc10 of scan signals respectively applied to first, j-th and n-th scan electrodes Y2_1, Y2_{—}j, and Y2_{—}n belonging to the second scan electrode group Y2 may be set to satisfy Equation (2):

Wsc5<Wsc6<Wsc7<Wsc8<Wsc9<Wsc10.

Referring to FIG. 13, a plurality of scan electrodes are divided into one or more scan electrode groups: a first scan electrode group Y1 and a second scan electrode group Y2. Widths Wsc11, Wsc12 and Wsc13 of scan signals respectively applied to first, i-th and j-th scan electrodes Y1_1, Y1_{—}i, and Y1_{—}n belonging to the first scan electrode group Y1 and widths Wsc14, Wsc15 and Wsc16 of scan signals respectively applied to first, j-th and n-th scan electrodes Y2_1, Y2_{—}j and Y2_{—}n belonging to the second scan electrode group Y2 may be set to satisfy Equation (3):

Wsc11=Wsc12=Wsc13

Wsc14=Wsc15=Wsc16

Wsc₁₁<Wsc14.

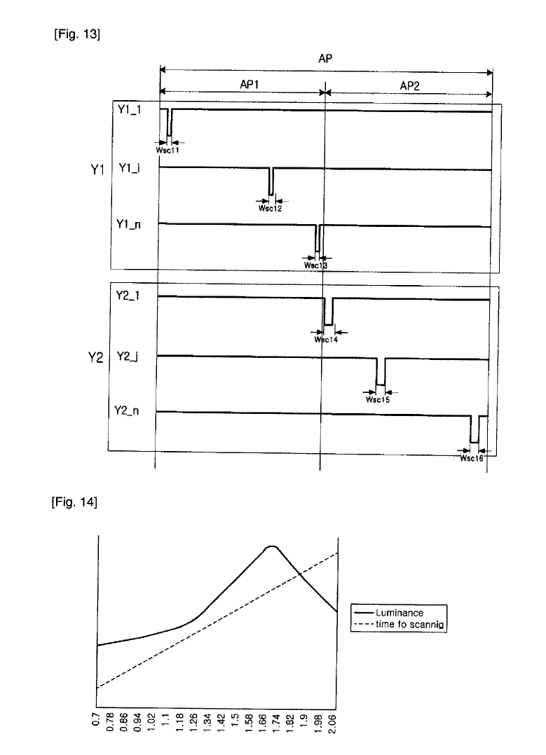

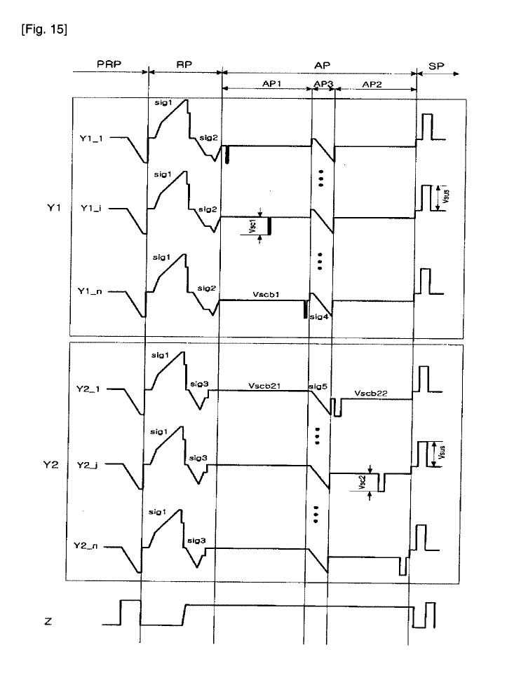

FIG. 14 illustrates graphs of the relationship between luminance and the ratio of the width of a scan signal applied to a first scan electrode group and the width of a scan signal applied to a second scan electrode group and the relationship between the duration of a scan period and the ratio of the width of a scan signal applied to the first scan electrode group and the width of a scan signal applied to the second scan electrode group. Referring to FIG. 14, a horizontal axis represents the ratio of the width of a scan signal applied to the first scan electrode group and the width of a scan signal applied to the second scan electrode group, and a vertical axis represents luminance and the duration of a scan period.

If the ratio of the width of a scan signal applied to the first scan electrode group and the width of a scan signal applied to the second scan electrode group is 1.2 or higher, a sufficient amount of time and a sufficient mount of spatial discharge to perform an address discharge may be secured, and thus, a sustain discharge may be stably performed. Then, luminance considerably increases. However, if the ratio of the width of a scan signal applied to the first scan electrode group and the width of a scan signal applied to the second scan electrode group is 1.2 or higher, wall charges accumulated in a dielectric material may be able to be easily erased, and thus, a sufficient voltage to cause an address discharge may not be able to be secured. The length of a frame for realizing a high-resolution image is limited. However, if the width of a scan signal is indefinitely increased, it may become difficult to realize a high-resolution image. The duration of a scan period may have a linear relationship with the ratio of the width of a scan signal applied to the first scan electrode group and the width of a scan signal. Given all this, the ratio of the width of a scan signal applied to the first scan electrode group and the width of a scan signal applied to the second scan electrode group may be 1.2 to 1.6.

FIG. 15 illustrates a timing diagram of the waveforms of driving signals according to another embodiment of the present invention. Referring to FIG. 14, a plurality of scan electrodes Y are divided into two scan electrode groups: a first scan electrode group Y1 and a second scan electrode group Y2. Then, different driving signals may be applied to the first and second scan electrode groups Y1 and Y2.

More specifically, a reset period RP is divided into a set-up period and a set-down period. During the set-up period, a ramp-up signal sig2 having a voltage that gradually increases is applied to all the scan electrodes Y so that all discharge cells can cause minute discharges, and that wall charges can be generated.

During the set-down period, a ramp-down signal sig2 having a voltage that decreases gradually, but not continually, is applied to the first scan electrode group Y2. While the voltage of the ramp-down signal sig2 decreases gradually and continually, wall charges generated during the set-up period are erased. While the voltage of the ramp-down signal sig2 is uniformly maintained, the erase of wall charges may not be continuously performed. That is, the ramp-down signal sig2 may enable an erase discharge to be discontinuously performed during the set-down period. Therefore, it is possible to enable a less amount of wall charge to be erased from the first scan electrode group Y1 and thus to stabilize addressing.

The ramp-down signal sig2 may be applied to both the first and second scan electrode groups Y1 and Y2. Alternatively, the ramp-down signal sig2 may be applied only to one of the first and second scan electrode groups Y1 and Y2 in which an address discharge occurs first. For example, the ramp-down signal sig2 may be applied only to the first scan electrode group Y1, and a ramp-down signal sig3 whose voltage decreases gradually and continually may be applied to the second scan electrode group Y2. Since a high bias voltage is applied to the second scan electrode group Y2, a less amount of wall charge is erased from the second scan electrode group Y2. There are many activated electrode in the first scan electrode group Y1 due to an address discharge, whereas there are only a few activated electrons in the second scan electrode group Y2. Thus, only a small amount of wall charge may be erased from the second scan electrode group Y2.

As described above, according to the present invention, it is possible to stably perform an address discharge and thus to reduce the number of discharge cells that do not cause a discharge. In addition, it is possible to improve the quality of pictures. Moreover, even if the duration of an address period increases in order to realize a high-resolution image, it is possible to stably perform an address discharge and thus to effectively realize high-resolution images.

The present invention can be realized as computer-readable code written on a computer-readable recording median. The computer-readable recording medium may be any type of recording device in which data is stored in a computer-readable manner. Examples of the computer-readable recording medium include a ROM, a RAM, a CD-ROM, a magnetic tape, a floppy disc, an optical data storage, and a carrier wave (e.g., data transmission through the Internet). The computer-readable recording medium can be distributed over a plurality of computer systems connected to a network so that computer-readable code is written thereto and executed therefrom in a decentralized manner. Functional programs, code, and code segments needed for realizing the present invention can be easily construed by one of ordinary skill in the art.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A plasma display device comprising:
a plasma display panel (PDP) which includes an upper substrate, a lower substrate, a plurality of scan electrodes and a plurality of sustain electrodes that are disposed on the upper substrate, and a plurality of address electrodes that are disposed on the lower substrate; and
a driving unit which applies driving signals to the scan electrodes, the sustain electrodes and the address electrodes,
wherein the scan electrodes are divided into a plurality of scan electrode groups including first and second scan electrode groups, a plurality of scan signals are applied to the scan electrodes in units of the scan electrode groups, at least one of a plurality of subfields of a frame comprises a reset period, an address period and a sustain period, the address period comprises a first sub-address period during which the scan signals are applied to the first scan electrode group and a second sub-address period during which the scan signals are applied to the first scan electrode group, a first scan bias voltage is applied to the second scan electrode group during the first sub-address period, a second scan bias voltage is applied to at least one of the scan electrode groups during the second sub-address period, the first and second scan bias voltages are different from each other, and a minimum voltage of a set-down signal which is applied to the second scan electrode group during the reset period and has a voltage that gradually decreases is higher than a scan voltage applied to the scan electrodes during the address period.

2. The plasma display device of claim 1, wherein a reduced voltage difference between the minimum voltage of the set-down signal and the scan voltage varies from one scan electrode group to another.

3. The plasma display device of claim 2, wherein a minimum voltage of a set-down signal applied to whichever of the scan electrode groups causes an address discharge first is substantially the same as the scan voltage.

4. The plasma display device of claim 2, wherein the reduced voltage difference is 5-35 V.

5. The plasma display device of claim 2, wherein a first reduced voltage difference detected from a first subfield is different from a second reduced voltage difference detected from a second subfield.

6. The plasma display device of claim 5, wherein the second subfield follows the first subfield, and the first reduced voltage is greater than the second reduced voltage.

7. The plasma display device of claim 1, wherein the at least one subfield further comprises a pre-reset period which is followed by the reset period and during which a ramp-down signal having a voltage that gradually decreases is applied to the scan electrodes and a sustain bias signal having an opposite polarity to that of the ramp-down signal is applied to the sustain electrodes.

8. The plasma display device of claim 1, wherein the scan signals comprise a first scan signal and a second scan signal that have different widths.

9. The plasma display device of claim 1, wherein a first width of a scan signal applied during the first sub-address period is less than a second width of a scan signal applied during the second sub-address period.

10. The plasma display device of claim 9, wherein the second width is 1.2-1.6 times greater than the first width.

11. The plasma display device of claim 1, wherein the first scan bias voltage is higher than the second scan bias voltage and lower than a sustain voltage applied to the scan electrodes during the sustain period.

12. The plasma display device of claim 1, wherein the first scan bias voltage is higher than the result of multiplying a maximum voltage of an address signal applied to the address electrodes and the second scan bias voltage by −1 and lower than a difference between a maxi nun voltage of a sustain signal and the maximum voltage of the address signal.

13. The plasma display device of claim 1, wherein the first scan bias voltage is a ground voltage.

14. The plasma display device of claim 1, wherein the second scan bias voltage is a negative voltage.

15. The plasma display device of claim 1, wherein a scan bias voltage applied to the first scan electrode group during the first sub-address period is substantially the same as the first scan bias voltage.

16. The plasma display device of claim 1, wherein the reset period comprises:
a set-up period during which a ramp-up signal having a voltage that gradually increases is applied to at least one of the scan electrode groups; and
a set-down period during which a ramp-down signal having a voltage that decreases gradually, but not continually, is applied.

17. The plasma display device of claim 1, wherein the scan electrodes are divided into a first scan electrode group including upper scan electrodes and a second scan electrode group including lower scan electrodes.

18. The plasma display device of claim 1, wherein the scan electrodes are divided into a first scan electrode group including odd-numbered scan electrodes and a second scan electrode group including even-numbered scan electrodes.

19. A method of driving a PDP which includes an upper substrate, a lower substrate, a plurality of scan electrodes and a plurality of sustain electrodes that are disposed on the upper substrate, and a plurality of address electrodes that are disposed on the lower substrate,
wherein the scan electrodes are divided into a plurality of scan electrode groups including first and second scan electrode groups, a plurality of scan signals are applied to the scan electrodes in units of the scan electrode groups, at least one of a plurality of subfields of a frame comprises a reset period, an address period and a sustain period, the address period comprises a first sub-address period during which the scan signals are applied to the first scan electrode group and a second sub-address period during which the scan signals are applied to the first scan electrode group, a first scan bias voltage is applied to the second scan electrode group during the first sub-address period, a second scan bias voltage is applied to at least one of the scan electrode groups during the second sub-address period, the first and second scan bias voltages are different from each other, and a minimum voltage of a set-down signal which is applied to the second scan electrode group during the reset period and has a voltage that gradually decreases is higher than a scan voltage applied to the scan electrodes during the address period.

20. The method of claim 19, wherein a reduced voltage difference between the minimum voltage of the set-down signal and the scan voltage varies from one scan electrode group to another.
